(19) United States
(12) Patent Application Publication
(10) Pub. No.: US 2026/0134257 A1
(43) Pub. Date: May 14, 2026

(54) METHODS, SYSTEMS AND COMPUTER PROGRAM PRODUCTS FOR DEBIASING TRAINING DATA FOR MACHINE LEARNING MODELS

(71) Applicant: MASTERCARD INTERNATIONAL INCORPORATED, PURCHASE, NY (US)

(72) Inventors: Deepanshu ., New Delhi (IN); Puspita Majumdar, Kolkata (IN)

(21) Appl. No.: 18/946,899

(22) Filed: Nov. 13, 2024

(51) Int. Cl. G06N 3/0455

(52) U.S. Cl. CPC G06N 3/0455

(57) ABSTRACT

The invention enables debiasing of machine learning model training data. A training data set is obtained, and is segregated into a privileged group data set and an unprivileged group data set. A first latent space data set is generated by encoding the unprivileged group data set. A second latent space data set is generated by encoding the privileged group data set. A second data distribution corresponding to the second latent space data set satisfies a defined similarity threshold when compared with a first data distribution corresponding to the first latent space data set. A reconstructed unprivileged group data set and a reconstructed unprivileged group data set are generated based respectively on the first latent space data set and the second latent space data set. Data samples from each of the reconstructed unprivileged group data set and the reconstructed privileged group data set are aggregated into a debiased data set.

### FIELD OF THE INVENTION

The present invention relates to training or configuring machine learning models for performing a task, and more particularly to methods, systems and computer program products for debiasing training data that for use in training or configuring a machine learning model.

### BACKGROUND OF THE INVENTION

FIG. 1 illustrates a prior art system environment 100 for training a machine learning model 102 for an intended task. Training machine learning model 102 involves selecting a training data set 104 - and providing training data samples from within training data set 104 as inputs to machine learning model 102. Machine learning model 102 is iteratively trained or updated or configured using the training data samples, until outputs generated from machine learning model 102 are found to satisfy one or more defined acceptability criteria associated with the task for which machine learning model 102 is being trained.

FIG. 2 is a flowchart illustrating a prior art method of training a machine learning model 102.

Step 202 of the method comprises obtaining a training data set 104. The training data set 104 comprises a plurality of data samples that are intended to be used as inputs for training or configuring machine learning model 102.

Step 204 comprises passing training data samples from within training data set 104 as inputs to machine learning model 104.

At step 206, based on the training data samples that are provided as inputs, machine learning model 102 is iteratively trained or modified until outputs that are generated based on said inputs, are found to satisfy one or more defined acceptability criteria.

At step 208, the resulting training machine learning model 102 is utilized for performing a task for which it has been trained or configured.

It is known in the domain of machine learning, that machine learning models can be operate in a biased manner, as a result of data samples that are used as training data for the purposes of training the models.

Bias can be understood as the tendency of a method or a model to overestimate, or underestimate a parameter. The process of collection of training data and the resulting training data sets routinely incorporate data biases—which can arise for a variety of reasons, including the method of collection of data, the method of data analysis, the entity or person that performs the collection or analysis, human design constraints, sampling constraints etc.

Biases that develop within a machine learning model result in sub-optimal predictive performance and/or sub-optimal decision making by the machine learning model.

For the purposes of the present invention, bias in a machine learning model may be understood as a difference in performance between different groups for a task, or as a result that is skewed towards a particular category or sub-category.

It has been observed that if a machine learning model acquires unintended biases, it is unable to properly identify or capture relationships between observed features and a target outcome.

There is accordingly a need for solutions to debias training data for machine learning models, prior to training said models with the data - so as to reduce or eliminate entirely machine learning model biases that arise as a result of biased training data.

### BRIEF DESCRIPTION OF THE ACCOMPANYING DRAWINGS

FIG. 1 illustrates a system environment for training a machine learning model for an intended task.

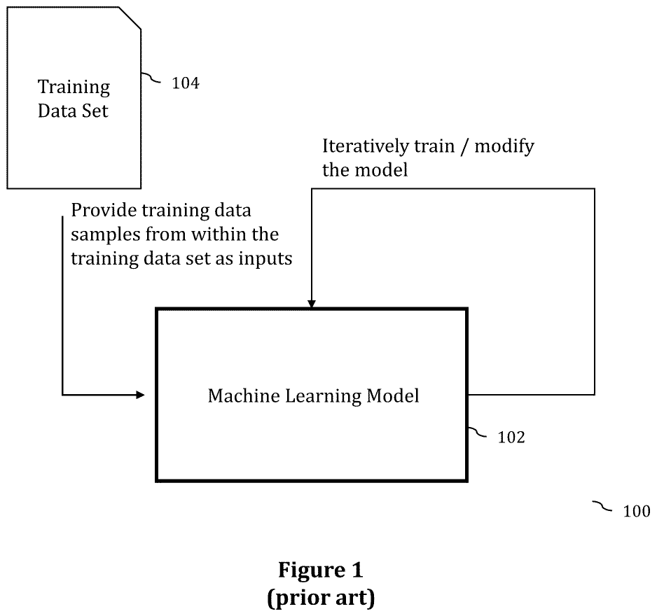

FIG. 2 is a flowchart illustrating a method of training the machine learning model of FIG. 1.

FIG. 3 illustrates a system environment for training a machine learning model using debiased training data in accordance with teachings of the present invention.

FIG. 4 is a flowchart illustrating a method of training a machine learning model of FIG. 3 using debiased training data.

FIG. 5 illustrates a process flow for debiasing training data in accordance with teachings of the present invention.

FIG. 6 is a flowchart illustrating a method for debiasing training data in accordance with teachings of the present invention.

FIG. 7 illustrates an autoencoder comprising an encoder that is configured for generating a first latent space data set corresponding to an unprivileged group data set, and a decoder for enabling reconstruction of a data set based on a latent space data set that is provided as an input for reconstruction.

FIG. 8 is a flowchart illustrating a method of training the autoencoder of FIG. 7.

FIG. 9 illustrates a neural network system that is configured for generating a second latent space data set corresponding to a privileged group data set.

FIG. 10 is a flowchart illustrating a method of training the neural network system of FIG. 9.

FIG. 11 illustrates a detailed embodiment of a system for debiasing training data in accordance with teachings of the present invention.

FIG. 12 is a flowchart illustrating a detailed embodiment of a method for debiasing training data by utilizing the system of FIG. 11, in accordance with teachings of the present invention.

FIG. 13 is a flowchart illustrating a method of training a machine learning model (of a kind shown in FIG. 3) using debiased training data arising from the method of FIG. 12, and utilizing the trained machine learning model.

FIG. 14 illustrates an exemplary system configured to implement the methods of the present invention.

FIG. 15 illustrates an exemplary computer system according to which various embodiments of the present invention may be implemented.

### SUMMARY

The present invention relates to training or configuring machine learning models for performing a task, and more particularly relates to methods, systems and computer program products for debiasing training data that is utilized for training or configuring a machine learning model.

The invention provides a computer implemented method for debiasing training data for training a machine learning model. In an embodiment, the method comprises implementing at, at least one processor, the steps of (i) obtaining a training data set comprising a plurality of data samples for use as inputs for training the machine learning model, wherein the plurality of data samples includes privileged group data samples and unprivileged group data samples, (ii) segregating the plurality of data samples into (a) a privileged group data set comprising the privileged group data samples, and (b) an unprivileged group data set comprising the unprivileged group data samples, (iii) generating a first latent space data set based on the unprivileged group data set, wherein generating the first latent space data set comprises (c) providing the unprivileged group data set to an encoder within an autoencoder, said autoencoder comprising the encoder and a decoder, and (d) generating the first latent space data set by encoding the unprivileged group data set at the encoder, (iv) generating a second latent space data set based on the privileged group data set, wherein generating the second latent space data set comprises (e)providing the privileged group data set to an adversarial encoder, (f) providing the first latent space data set to a discriminator, and (g) generating the second latent space data set by encoding the privileged group data set at the adversarial encoder, such that a second data distribution corresponding to the second latent space data set satisfies a defined similarity threshold when compared with a first data distribution corresponding to the first latent space data set, (v) generating a reconstructed unprivileged group data set based on the first latent space data set, (vi) generating a reconstructed privileged group data set based on the second latent space data set, and (vii) generating a debiased training data set comprising data samples from each of the reconstructed unprivileged group data set and the reconstructed privileged group data set.

The invention also provides a system for debiasing training data for training a machine learning model. In an embodiment the system comprises at least a processor implemented autoencoder, a processor implemented adversarial encoder, and a processor implemented discriminator—wherein the system is configured to perform the steps of (i) obtaining a training data set comprising a plurality of data samples for use as inputs for training the machine learning model, wherein the plurality of data samples includes privileged group data samples and unprivileged group data samples, (ii) segregating the plurality of data samples into (a) a privileged group data set comprising the privileged group data samples, and (b) an unprivileged group data set comprising the unprivileged group data samples, (iii) generating a first latent space data set based on the unprivileged group data set, wherein generating the first latent space data set comprises (c) providing the unprivileged group data set to an encoder within an autoencoder, said autoencoder comprising the encoder and a decoder, and (d) generating the first latent space data set by encoding the unprivileged group data set at the encoder, (iv) generating a second latent space data set based on the privileged group data set, wherein generating the second latent space data set comprises (e)providing the privileged group data set to an adversarial encoder, (f) providing the first latent space data set to a discriminator, and (g) generating the second latent space data set by encoding the privileged group data set at the adversarial encoder, such that a second data distribution corresponding to the second latent space data set satisfies a defined similarity threshold when compared with a first data distribution corresponding to the first latent space data set, (v) generating a reconstructed unprivileged group data set based on the first latent space data set, (vi) generating a reconstructed privileged group data set based on the second latent space data set, and (vii) generating a debiased training data set comprising data samples from each of the reconstructed unprivileged group data set and the reconstructed privileged group data set.

The invention additionally provides a computer program product for debiasing training data for training a machine learning model. The computer program product comprises a non-transitory computer readable medium having a computer readable program code embodied therein, wherein the computer readable program code comprises instructions for performing at, at least one processor, the steps of (i) obtaining a training data set comprising a plurality of data samples for use as inputs for training the machine learning model, wherein the plurality of data samples includes privileged group data samples and unprivileged group data samples, (ii) segregating the plurality of data samples into (a) a privileged group data set comprising the privileged group data samples, and (b) an unprivileged group data set comprising the unprivileged group data samples, (iii) generating a first latent space data set based on the unprivileged group data set, wherein generating the first latent space data set comprises (c) providing the unprivileged group data set to an encoder within an autoencoder, said autoencoder comprising the encoder and a decoder, and (d) generating the first latent space data set by encoding the unprivileged group data set at the encoder, (iv) generating a second latent space data set based on the privileged group data set, wherein generating the second latent space data set comprises (e)providing the privileged group data set to an adversarial encoder, (f) providing the first latent space data set to a discriminator, and (g) generating the second latent space data set by encoding the privileged group data set at the adversarial encoder, such that a second data distribution corresponding to the second latent space data set satisfies a defined similarity threshold when compared with a first data distribution corresponding to the first latent space data set, (v) generating a reconstructed unprivileged group data set based on the first latent space data set, (vi) generating a reconstructed privileged group data set based on the second latent space data set, and (vii) generating a debiased training data set comprising data samples from each of the reconstructed unprivileged group data set and the reconstructed privileged group data set.

### DETAILED DESCRIPTION

The present invention relates to training or configuring machine learning models for performing a task, and provides methods, systems and computer program products for debiasing training data that can thereafter be utilized for training or configuring a machine learning model.

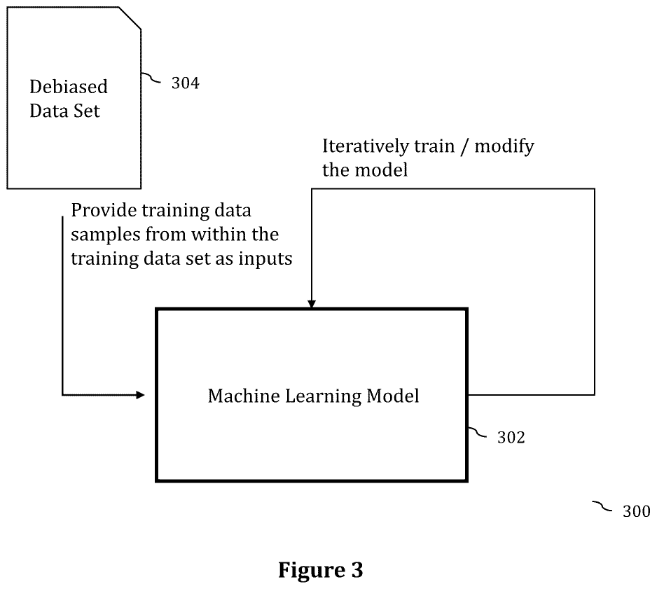

FIG. 3 illustrates a system environment 300 for training a machine learning model 302 using debiased training data 304 in accordance with teachings of the present invention. Training machine learning model 302 involves obtaining a debiased training data set 304 - and providing training data samples from within debiased training data set 304 as inputs to machine learning model 302. Machine learning model 302 is iteratively trained or modified or configured using the debiased training data samples, until outputs generated from machine learning model 302 are found to satisfy a defined acceptability criteria associated with the task for which machine learning model 302 is being trained.

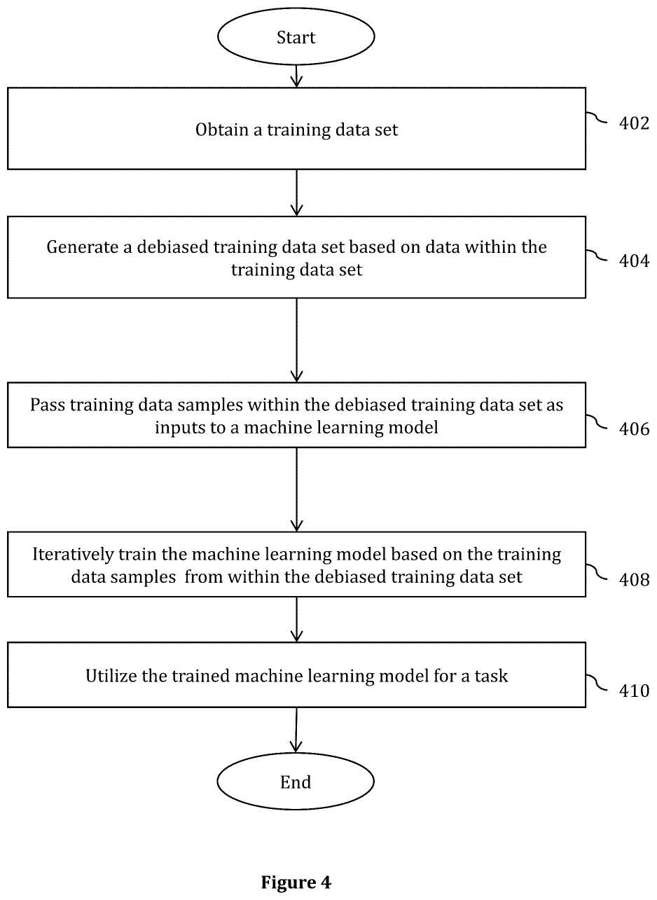

FIG. 4 is a flowchart illustrating a method of training machine learning 302 model of FIG. 3 using debiased training data.

Step 402 comprises obtaining a training data set 304. The training data set 304 comprises a plurality of data samples that are intended to be used as inputs for training or configuring machine learning model 302. In an embodiment, the plurality of data samples within training data set 304 comprise a first sub-set of data samples (i.e. a privileged group data set) that qualify as privileged group data samples, and a second sub-set of data samples (i.e. an unprivileged group data set) that qualify as unprivileged group data samples.

For the purposes of the invention, (i) a privileged group data sample shall mean a data sample that is expected or predicted to be unfairly benefited (for example, unfairly positively labeled) as a consequence of bias within the machine learning model that is being trained, and (ii) an unprivileged group data sample shall mean a data sample that is expected or predicted to be unfairly negatively impacted (for example, unfairly negatively labeled) by bias within the machine learning model that is being trained. In certain embodiments, (i) a privileged group data sample is a data sample having one or more attributes that have been historically or statistically more likely to result in receiving a favorable label in a machine learning binary classification task for which a machine learning model is intended to be trained using training data set 304, and (ii) an unprivileged group data sample is a data sample having one or more attributes that have been historically or statistically more likely to result in receiving an unfavorable label in a machine learning binary classification task for which a machine learning model is intended to be trained using training data set 304.

Step 404 comprises generating a debiased training data set based on data within training data set 304. Methods for generating a debiased training data set in accordance with the present invention are described in more detail subsequently.

Step 406 comprises providing training data samples from within debiased training data set 304, as inputs to machine learning model 302.

At step 408, based on the provided inputs (i.e. based on the training data samples from within debiased training data set 304), machine learning model 302 is iteratively trained or modified until outputs that are generated by machine learning model 302 based on said inputs, are found to satisfy a defined acceptability criteria.

Step 410 comprises utilizing the trained machine learning model 302 for an intended task for which it has been trained.

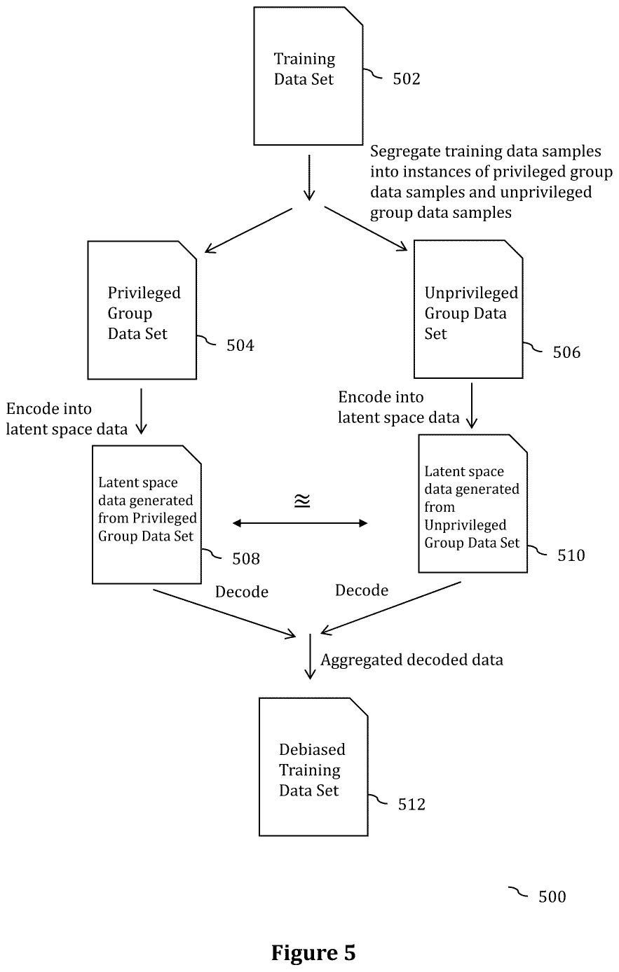

FIG. 5 illustrates a process flow 500 for debiasing training data in accordance with teachings of the present invention—such that the resulting debiased training data can subsequently be used to train a machine learning model 302 as described above in connection with FIGS. 3 and 4.

As shown in FIG. 5, a training data set 502 is obtained for the purposes of training a machine learning model. Training data set 502 comprises a plurality of data samples that are intended to be used as inputs for training or configuring the machine learning model. Data samples within the training data set are thereafter classified and segregated into instances of privileged group data samples and instances of unprivileged group data samples. In an embodiment, classification and segregation of an individual data sample as a privileged group data sample or as an unprivileged group data sample may be based on identification of one or more attributes of said individual data sample that is/are an identifier(s) of membership within or association with a privileged group or an unprivileged group respectively.

As a result, of the classification and segregation, data samples within training data set 502 are distributed between a privileged group data set 504 (comprising privileged group data samples) and an unprivileged group data set 506 (comprising unprivileged group data samples).

The unprivileged group data set 506 is thereafter encoded or transformed into a first latent space data set 510. In an embodiment, the dimensionality of the first latent space data set 510 is lower that the dimensionality of the unprivileged group data set 506.

For the purposes of this invention, the term ‘dimensionality’ shall be understood to mean a ‘number of dimensions.

In an embodiment the unprivileged group data set 506 is encoded or transformed into the first latent space data set 510 by an autoencoder. In a further embodiment, the autoencoder comprises an encoder and a decoder.

The privileged group data set 504 is thereafter encoded or transformed into a second latent space data set 508. In an embodiment, the dimensionality of the second latent space data set 508 is lower that the dimensionality of the privileged group data set 504. Critically, the invention seeks to ensure that the encoding or transformation of the privileged group data set 504 to generate the second latent space data set 508 is performed in a manner that ensures that data distribution within (or associated with) the encoded second latent space data set 508 satisfies a defined similarity threshold with data distribution within the encoded first latent space data set 510. In an embodiment of the invention, the encoding or transformation of privileged group data set 504 to generate second latent space data set 508 is performed by a neural network system comprising an adversarial encoder and a discriminator.

In an embodiment, the determination whether the data distribution within the second latent space data set 508 satisfies a defined similarity threshold with data distribution within the first latent space data set 510 (as mentioned both hereinabove, and also elsewhere within this written description), relies on a discriminator. In an embodiment, the discriminator comprises a processor implemented neural network classifier trained to predict whether a given input latent representation (i.e. an input latent space data set) has been generated based on data instances from a privileged group or based on data instances from an unprivileged group. Stated differently, in an embodiment, the discriminator is trained to distinguish between privileged and unprivileged group latent information. In an embodiment, the discriminator acts as an adversary to ensure that a privileged group instance based latent space data set is mapped in a manner that is similar to an unprivileged group instance based latent space data set. Thus in an embodiment, the first latent space data set 510 and the second latent space data set 508 would be determined (or identified) as satisfying a predefined similarity threshold if the discriminator is not able to distinguish between the two data sets.

Thereafter, (i) first latent space data set 510 is decoded or transformed to generate a first reconstructed data set, and (ii) second latent space data set 508 is decoded or transformed to generate a second reconstructed data set. In an embodiment, the step of decoding or transforming first latent space data set 510 to generate a first reconstructed data set is performed by the decoder within the autoencoder that has generated first latent space data set 510. In a more specific embodiment, the step of decoding second latent space data set 508 to generate a second reconstructed data set is also performed by the decoder within the autoencoder that has generated the first latent space data set 510.

Data samples within the first reconstructed data set and the second reconstructed data set are aggregated to generate a debiased training data set 512—which can be subsequently used for training a machine learning model (for example, in a manner described in the method of FIG. 4).

It has been discovered that by (i) encoding second latent space data set 508 in a manner such that data distribution within second latent space data set 508 satisfies a defined similarity threshold with data distribution within first latent space data set 510, (ii) and subsequently using the same decoder to reconstruct data sets based on each of the first and second latent space data sets 510, 508, results in reduction or elimination of bias in the reconstructed data sets—which can be aggregated and used as training data for a machine learning model. In an embodiment, a determination whether a data distribution within second latent space data set 508 satisfies a defined similarity threshold with a data distribution within first latent space data set 510, relies on a discriminator (for example, a processor implemented neural network classifier) that is configured to trained to predict whether a given input latent representation (i.e. an input latent space data set) has been generated based on data instances from a privileged group or based on data instances from an unprivileged group. In an embodiment, the discriminator is trained or configured to function as an adversary to ensure that a privileged group instance based latent space data set (i.e. the second latent space data set 508) is mapped in a manner that is similar to an unprivileged group instance based latent space data set (i.e. the first latent space data set 510). Thus in an embodiment, the first latent space data set 510 and the second latent space data set 508 would be determined (or identified) as satisfying a predefined similarity threshold if the discriminator is not able to distinguish between the two data sets.

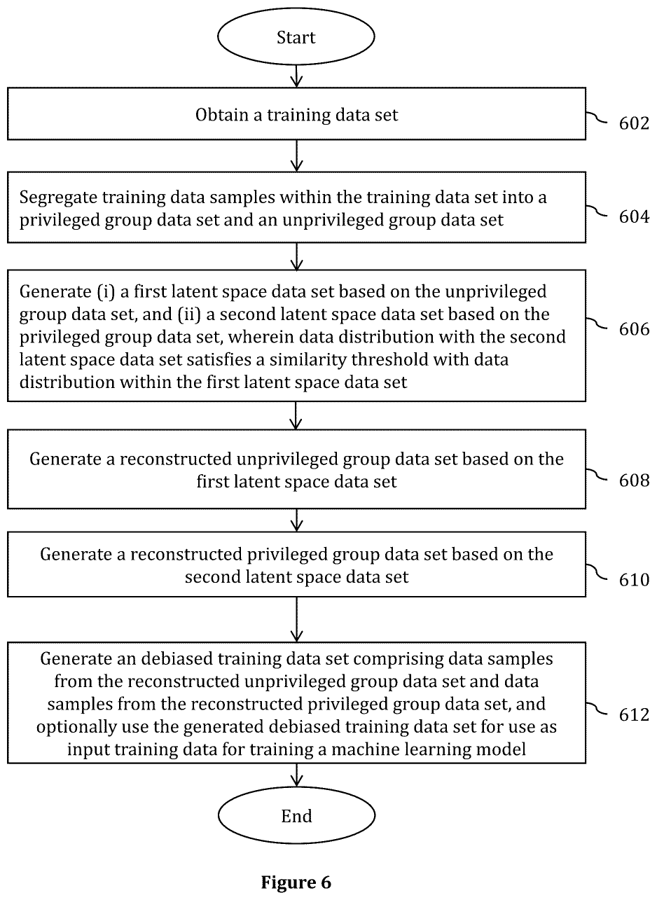

FIG. 6 is a flowchart illustrating a method for debiasing training data.

FIG. 602 comprises obtaining a training data set 502. In an embodiment, training data set 502 is obtained for the purposes of training a machine learning model. Training data set 502 comprises a plurality of data samples that are intended to be used as inputs for training or configuring the machine learning model.

At step 604 data samples within training data set 502 are classified and segregated into a privileged group data set 504 (comprising instances of privileged group data samples) and an unprivileged group data set 506 (comprising instances of unprivileged group data samples). In an embodiment classification and segregation of an individual data sample as a privileged group data sample or as an unprivileged group data sample is based on identification of one or more attributes of said individual data sample that is / are an identifier(s) of membership within or association within a privileged group or an unprivileged group respectively.

Step 606 comprises generating (i) a first latent space data set 510 based on the unprivileged group data set 506, and (ii) a second latent space data set 508 based on the privileged group data set 504—wherein data distribution within second latent space data set 506 satisfies a similarity threshold with data distribution within first latent space data set 510.

In an embodiment, (i) the dimensionality of first latent space data set 510 is lower that the dimensionality of unprivileged group data set 506 and/or (ii) the dimensionality of second latent space data set 508 is lower that dimensionality of the privileged group data set 504. In an embodiment, first latent space data set 510 is generated (based on unprivileged group data set 506) by an autoencoder. In a further embodiment, the autoencoder comprises an encoder and a decoder. In an embodiment second latent space data set 508 is generated (based on privileged group data set 504) by a neural network system comprising an adversarial encoder and a discriminator.

Step 608 comprises generating a reconstructed unprivileged group data set based on first latent space data set 510. In an embodiment, the step of generate a reconstructed unprivileged group data set based on first latent space data set 510, is performed by a decoder within the autoencoder that has generated first latent space data set 510. In an embodiment, the reconstructed unprivileged group data set resulting from step 608 is identical or similar to unprivileged group data set 506 that has been used to generate the first latent space data set 510.

Step 610 comprises generating a reconstructed privileged group data set based on second latent space data set 508. In an embodiment, the step of generating a reconstructed privileged group data set based on second latent space data set 508, is performed by the decoder within the autoencoder that has generated first latent space data set 510. The reconstructed privileged group data set resulting from step 610 is different from the privileged group data set 504 that has been used to generate second latent space data set 508.

Step 612 comprises generating a debiased training data set comprising data samples from the reconstructed unprivileged group data set and data samples from the reconstructed privileged group data set.

The generated debiased training data set may thereafter be used as input training data for training a machine learning model (for example, in accordance with the method steps of the method of FIG. 4).

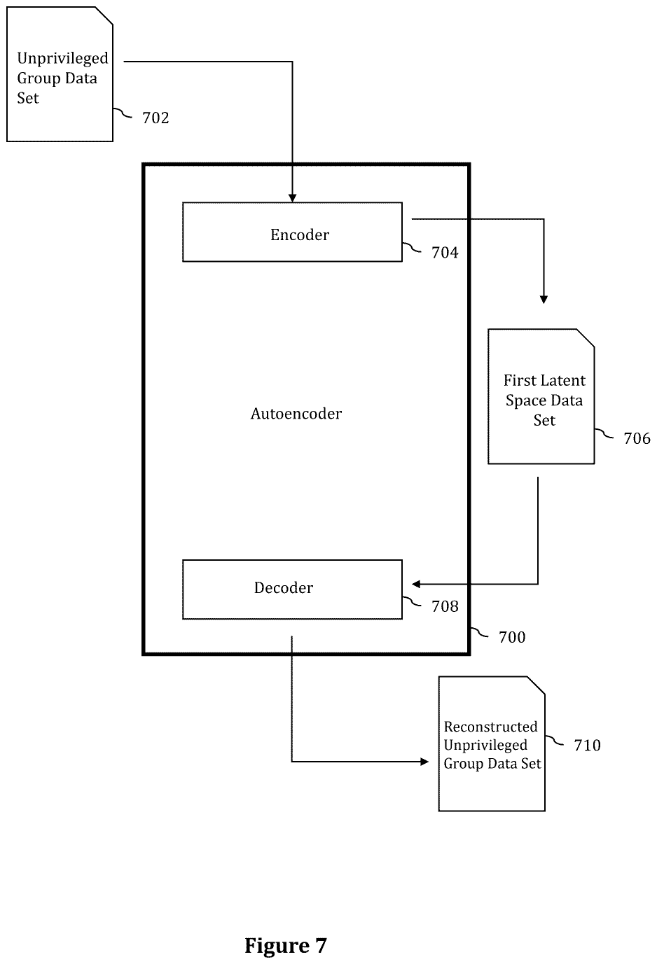

FIG. 7 illustrates an autoencoder 700 that has been configured for implementing the step of generating a first latent space data set 706 based on the unprivileged group data set 702 (as described in connection with step 606 of the method of FIG. 6), and for subsequently generating a reconstructed unprivileged group data set 710 based on the encoded first latent space data set 706. Auto-encoder 700 comprises encoder 704 and decoder 708. In an embodiment, decoder 708 of autoencoder 700 may additionally be utilized to generate a reconstructed privileged group data set based on a second latent space data set 508 that has been encoded based on a privileged group data set, by a neural network system (described subsequently) comprising an adversarial encoder and a discriminator, wherein the adversarial encoder has been trained or configured by a discriminator.

Encoder 704 is configured to receive as input data, an unprivileged group data set 702 (that has been segregated or extracted from a training data set—for example, according to step 604 of the method of FIG. 6) and to generate based on unprivileged group data set 702, a first latent space data set 706. In an embodiment, encoder 704 is configured such that the dimensionality of first latent space data set 706 is lower that the dimensionality of unprivileged group data set 702.

Decoder 708 is configured to receive as input data, a latent space data set (for example first latent space data set 706) and to decode the received latent space data set to generate a reconstructed data set. In an embodiment, decoder 708 is configured such that a dimensionality of the reconstructed data set is higher than a dimensionality of the latent space data set that is received as input data at decoder 708.

As discussed in more detail below, decoder 708 may be utilized for one or both of (i) receiving as input data, first latent space data set 706, 510 that has been generated based on an unprivileged group data set 702, 506, and decoding the first latent space data set 706, 510 and generating as output, a reconstructed unprivileged group data set 710, and (ii) receiving as input data, a second latent space data set 508 that has been generated based on privileged group data set 504, and decoding the second latent space data set 508 and generating as output, a reconstructed privileged group data set.

In an embodiment of the invention, autoencoder 700 may be trained or configured, by iteratively training or configuring the encoder 704 and/or decoder 708 based on input data (for example, input data comprising unprivileged group data samples)—wherein encoder 704 and decoder 708 are iteratively trained or configured until a measured reconstruction loss (L_{rec}) associated with autoencoder 700 (i.e. arising out of the functioning of said encoder 704 and decoder 708) converges.

In an embodiment of the invention, autoencoder 700 may be trained or configured, by iteratively training or configuring the encoder 704 and/or decoder 708 based on input data (for example, input data comprising unprivileged group data samples)—wherein encoder 704 and decoder 708 are iteratively trained or configured until a measured reconstruction loss (Lrec) associated with autoencoder 700 (i.e. arising out of the functioning of said encoder 704 and decoder 708) converges.

In another embodiment of the invention, autoencoder 700 may be trained or configured, by iteratively training or configuring the encoder 704 and decoder 708 based on input data (for example, input data comprising unprivileged group data samples)—wherein the encoder 704 and decoder 708 are iteratively trained or configured (i) until a measured reconstruction loss (L_{rec}) associated with autoencoder 700 (i.e. arising out of the functioning of said encoder 704 and decoder 708) converges and (ii) until a measured main task classification loss (Lₘₜ) converges.

In another embodiment of the invention, autoencoder 700 may be trained or configured, by iteratively training or configuring the encoder and/or decoder 708 based on input data (for example, input data comprising unprivileged group data samples)—wherein the encoder 704 and decoder 708 are iteratively trained or configured until a measured total loss (Lₜₒₜₐₗ) associated with autoencoder 700 (i.e. arising out of the functioning of said encoder 704 and decoder 708)—which is determined as the sum of measured reconstruction loss (L_{rec}) and measured main task classification loss (Lₘₜ) (i.e. L_{Total}=L_{rec}+Lₘₜ)—converges.

For the purposes of the above embodiments:
“Reconstruction loss” shall be understood to mean:
Reconstruction loss is a measure used in machine learning, to quantify how well a model can recreate the input data from a compressed or encoded representation. In simple terms, reconstruction loss compares the original input data to the data that the model reconstructs after passing through its encoding and decoding processes. The goal is to minimize this loss, so the reconstructed output closely resembles the original input. Reconstruction loss aids in learning a meaningful encoded representation that closely resembles the input data. This encoded representation is then utilized for the debiasing task. We have used Mean Square Error (MSE) for reconstruction loss function.
“Main task classification loss” shall be understood to mean:
A main task loss (or primary loss) in machine learning refers to the loss function associated with the main objective or goal of the model, which is often related to the task it is being trained to accomplish. This loss quantifies how well the model performs on its primary task, such as classification, regression, or prediction. For example, in a classification task, the main task loss could be cross-entropy loss, which measures how well the model predicts the correct class labels.

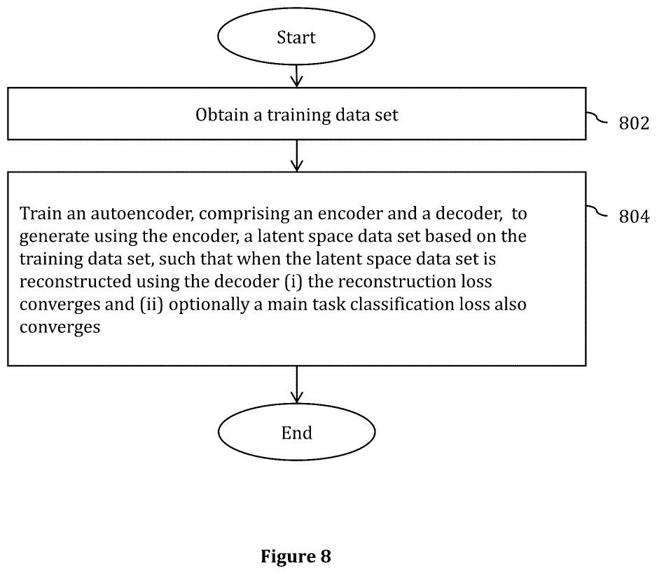

FIG. 8 is a flowchart illustrating a method of training the autoencoder 700 of FIG. 7.

Step 802 comprises obtaining a training data set comprising a set of data samples intended for training autoencoder 700. In an embodiment, the training data set obtained at step 802 is an unprivileged group data set that has been extracted from a larger data set.

Step 804 comprises training or configuring autoencoder 700 (which comprises encoder 704 and decoder 708) to generate using encoder 704, a latent space data set based on the training data set, wherein when the latent space data set is reconstructed using decoder 708 such that (i) a measured reconstruction loss (L_{rec}) converges and/or (ii)a measured main task classification loss (Lₘₜ) converges.

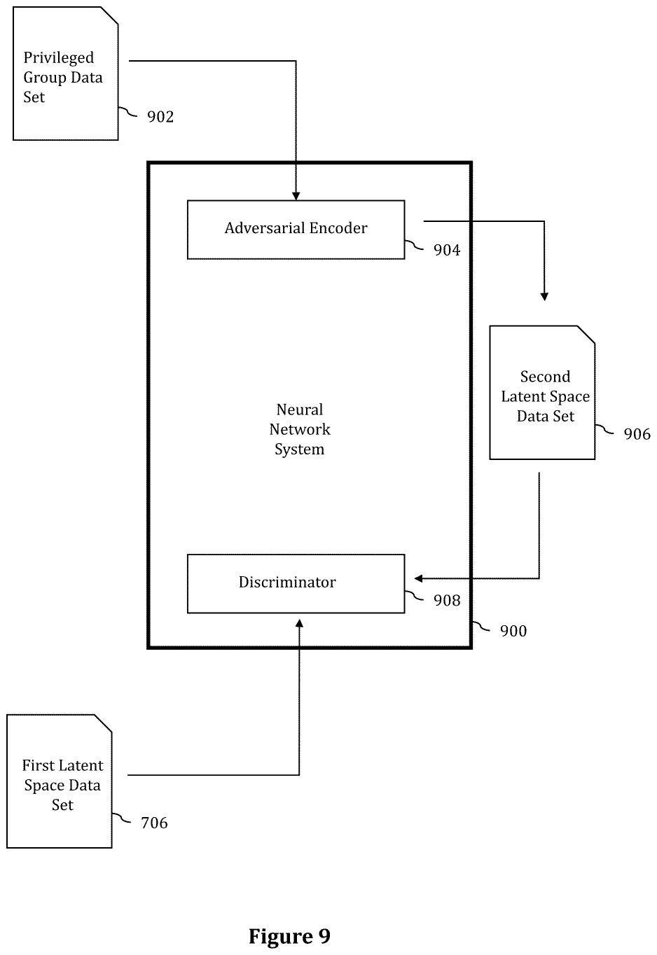

FIG. 9 illustrates a neural network system 900 that is configured for generating a second latent space data set 906 by encoding a privileged group data set 902 (as described in connection with step 606 of the method of FIG. 6).

Neural network system 900 comprises adversarial encoder 904 and discriminator 908. Adversarial encoder 904 is configured to receive as input data, a privileged group data set 902 (that has been segregated or extracted from a training data set—for example, according to step 604 of the method of FIG. 6) and to output based on the privileged group data set 902, a second latent space data set 906. In an embodiment, adversarial encoder 904 is configured such that the dimensionality of the second latent space data set 906 is lower that the dimensionality of the privileged group data set 902.

Discriminator 908 is configured to receive as input data, a candidate latent space data set that has been output by adversarial encoder 904 (for example second latent space data set 906) and to determine whether a first data distribution within (or associated with) the candidate latent space data set satisfies a defined similarity threshold when compared with a second data distribution within (or associated with) a reference latent space data set. Both of adversarial encoder 904 and discriminator 908 are iteratively trained or configured using the input data, until the first data distribution within (or associated with) the candidate latent space data set satisfies a defined similarity threshold when compared with the second data distribution within (or associated with) the reference latent space data set (i.e. the reference latent space data set). In an embodiment of neural network system 900, discriminator 908 is configured to (i) receive the second latent space data set that has been generated by adversarial encoder 904 and to use this second latent space data set as the candidate latent space data set, and (ii) receive the first latent space data set that has been generated by the encoder 704 of the autoencoder 700 (that has been described in connection with FIGS. 5 and 7) and to use the received first latent space data set as the reference latent space data set.

In an embodiment of the invention, neural network system 900 may be trained or configured, by iteratively training or configuring adversarial encoder 904 and discriminator 908 based on input data comprising privileged group data samples, and based on a latent space data set received from autoencoder 700 (or from encoder 704 within autoencoder 700)—wherein adversarial encoder 904 and discriminator 908 are iteratively trained or configured until the first data distribution within (or associated with) the candidate latent space data set that has been output by adversarial encoder 904 is found to satisfy a defined similarity threshold when compared with the second data distribution within (or associated with) the reference latent space data set that has been generated by the encoder 704 of the autoencoder 700.

In an embodiment, a determination whether the first data distribution within the candidate latent space data set satisfies a defined similarity threshold with the second data distribution within (or associated with) the reference latent space data set, relies on discriminator 908 (which in an embodiment is a processor implemented neural network classifier) that is configured to trained to predict whether a given input latent representation (i.e. a candidate latent space data set) has been generated based on data instances from a privileged group or based on data instances from an unprivileged group. In an embodiment, the discriminator 908 is trained or configured to function as an adversary to ensure that the candidate latent space data set is mapped in a manner that is similar to the reference latent space data set. Thus in an embodiment, the reference latent space data set and the candidate latent space data set would be determined (or identified) as satisfying a predefined similarity threshold when the discriminator 908 is not able to distinguish between the two data sets.

Upon determining that the first data distribution within (or associated with) the candidate latent space data set that has been output by adversarial encoder 904 satisfies a defined similarity threshold when compared with the second data distribution within (or associated with) the reference latent space data set that has been generated by the encoder 704 of the autoencoder 700, (i) neural network system 900 is considered/tagged as being suitably trained or configured, and/or (ii) the candidate latent space data set having the first data distribution that has been found to satisfy the defined similarity threshold with the second data distribution is output as the second latent space data set 906.

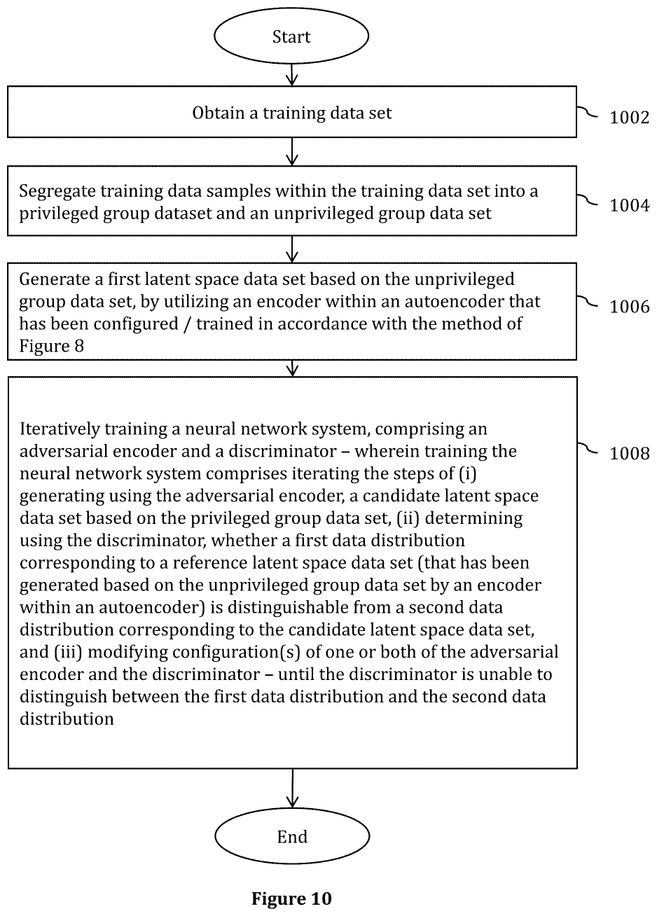

FIG. 10 is a flowchart illustrating a method of training the neural network system of FIG. 9.

Step 1002 comprises obtain a training data set comprising a set of data samples. The training data set obtained at step 1002 comprises privileged group data samples as well as unprivileged group data samples.

Step 1004 comprises segregating training data samples within the training data set into a privileged group data set comprising instances of privileged group data samples and an unprivileged group data set comprising instances of unprivileged group data samples. In an identification and segregation of an individual data sample as a privileged group data sample or as an unprivileged group data sample may be based on identification of one or more attributes of said individual data sample that is/are an identifier(s) of membership within or association within a privileged group or an unprivileged group respectively.

Step 1006 comprises generating a first latent space data set based on the unprivileged group data set—wherein generating the first latent space data set comprises (i) providing the unprivileged group data set as input to an encoder 704 within an autoencoder 700 that has been configured/trained in accordance with the method of FIG. 8, and (ii) receiving as an output from the encoder 704, the first latent space data set that has been generated by encoder 704 based on the input unprivileged group data set.

Step 1008 comprises iteratively training a neural network system 900, which comprises an adversarial encoder 904 and a discriminator 908—wherein training the neural network system 900 comprises iterating the steps of (i) generating using the adversarial encoder, 904 a candidate latent space data set based on the privileged group data set, (ii) determining using the discriminator 908, whether a first data distribution corresponding to a reference latent space data set (that has been generated based on the unprivileged group data set by an encoder 704 within an autoencoder 700, according to the description provided in connection with FIGS. 6 and 7) is distinguishable from a second data distribution corresponding to the candidate latent space data set (that has been generated by the adversarial encoder 904), and (iii) modifying the configuration(s) of one or both of the adversarial encoder 904 and the discriminator 908—wherein the above steps are iterated until the discriminator 908 is unable to distinguish (or to accurately distinguish according to a defined accuracy threshold) between the first data distribution and the second data distribution.

In an embodiment of the method of FIG. 10, adversarial encoder 904 and discriminator 908 are iteratively trained or configured until the first data distribution within (or associated with) the candidate latent space data set that has been output by adversarial encoder 904 satisfies a defined similarity threshold when compared (by discriminator 908) with the second data distribution within (or associated with) the reference latent space data set that has been generated by the encoder 704 of the autoencoder 700.

Upon determining that the first data distribution within (or associated with) the candidate latent space data set that has been output by adversarial encoder 904 satisfies a defined similarity threshold when compared with the second data distribution within (or associated with) the reference latent space data set that has been generated by the encoder 704 of the autoencoder 700, (i) the neural network system 900 is considered/tagged as being suitably trained or configured, and (ii) optionally the candidate latent space data set having the first data distribution that has been found to satisfy the defined similarity threshold with the second data distribution, is output as a second latent space data set.

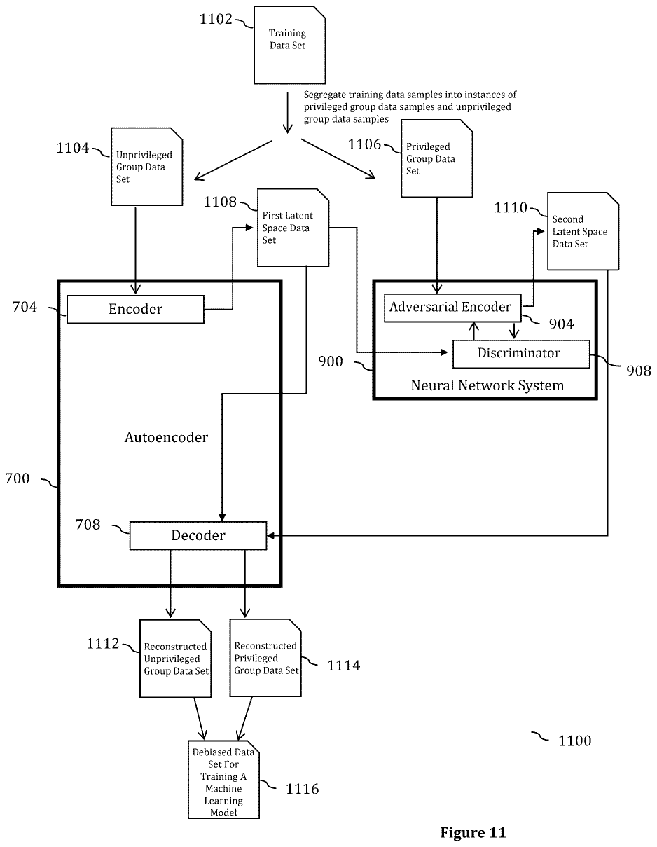

FIG. 11 illustrates a detailed embodiment of a system 100 for debiasing training data in accordance with teachings of the present invention.

As shown in FIG. 11, a training data set 1102 is obtained for the purposes of training a machine learning model. Training data set 1102 comprises a plurality of data samples that are intended to be used as inputs for training or configuring the machine learning model. Data samples within training data set 1102 are thereafter classified and segregated into instances of privileged group data samples and instances of unprivileged group data samples. The unprivileged group data samples are aggregated into unprivileged group data set 1104, while the privileged group data samples are aggregated into privileged group data set 1106.

In an embodiment classification and segregation of an individual data sample as a privileged group data sample or as an unprivileged group data sample may be based on identification of one or more attributes of said individual data sample that is/are an identifier(s) of membership within or association within a privileged group or an unprivileged group respectively.

The unprivileged group data set 1104 is thereafter provided as input to encoder 704 within autoencoder 700. For the purposes of FIG. 11, autoencoder 700 as well as encoder 704 and decoder 708 therewithin shall be understood as having been trained/configured in accordance with the description provided in connection with FIGS. 7 and 8 hereinabove. Encoder 704 encodes the unprivileged group data set 1104 into a first latent space data set 1108. In an embodiment, the dimensionality of the first latent space data set 1108 is lower that the dimensionality of the unprivileged group data set 1104.

The privileged group data set 1106 and the first latent space data set 1108 are provided as inputs to generative adversarial encoder 900. For the purposes of FIG. 11, generative adversarial encoder 900 as well as adversarial encoder 904 and discriminator 908 therewithin shall be understood as having been configured (or capable of being configured) in accordance with the description provided in connection with FIGS. 9 and 10 hereinabove.

In an embodiment, the neural network system 900 (and/or one or both of adversarial encoder 904 and discriminator 908) is trained or configured, by iteratively training or configuring adversarial encoder 904 and discriminator 908 based on privileged group data samples within the privileged group data set 1106 that is provided as input, and also based on the first latent space data set 1108 that is received from autoencoder 700 (or from encoder 704 within autoencoder 700). In particular, adversarial encoder 904 and discriminator 908 are iteratively trained or configured until a first data distribution within (or associated with) a candidate latent space data set that has been generated by adversarial encoder 904 based on the privileged group data set 1106 satisfies a defined similarity threshold when compared with a second data distribution within (or associated with) the first latent space data set 1108 that has been generated by the encoder 704 of the autoencoder 700. Upon determining that the first data distribution within (or associated with) the candidate latent space data set that has been output by adversarial encoder 904 satisfies a defined similarity threshold when compared with the second data distribution within (or associated with) the first latent space data set 1108 that has been generated by the encoder 704 of the autoencoder 700, (i) the neural network system 900 (and/or adversarial encoder 904 and discriminator 908) is considered/tagged as being suitably trained or configured, and/or (ii) the candidate latent space data set having the first data distribution that has been found to satisfy the defined similarity threshold with the second data distribution is output as second latent space data set 1110.

The first latent space data set 1108 (that has been generated by encoder 704) is provided as a first set of inputs to decoder 708—which generates a reconstructed unprivileged group data set 1112 based on said first latent space data set 1108. In an embodiment, decoder 708 is configured such that a dimensionality of the reconstructed unprivileged group data set 1112 is higher than a dimensionality of the first latent space data set 1108 that is received as input data at decoder 708.

The second latent space data set 1110 (that is output by adversarial encoder 904) is provided as a second set of inputs to decoder 708—which generates a reconstructed privileged group data set 1114 based on said second latent space data set 1110. In an embodiment, decoder 708 is configured such that a dimensionality of the reconstructed privileged group data set 1114 is higher than a dimensionality of the second latent space data set 1110 that is received as input data at decoder 708.

Thereafter, data samples respectively within the reconstructed unprivileged group data set 1112 and the reconstructed privileged group data set 1114 are aggregated/combined to generate a debiased training data set 1116—which can be subsequently used for training a machine learning model (for example, in a manner described in the method of FIG. 4).

As described above, by (i) encoding second latent space data set 1110 in a manner that ensures that a data distribution within second latent space data set 1110 satisfies a defined similarity threshold with a data distribution within first latent space data set 1108, (ii) and subsequently using a common decoder 708 to generate reconstructed data sets 1112 1114 based on each of the first and second latent space data sets 1108, 1110 respectively, results in reduction or elimination of bias in the reconstructed data sets 1112, 1114—which can therefore be aggregated into a debiased data set 1116 and used as training data for a machine learning model.

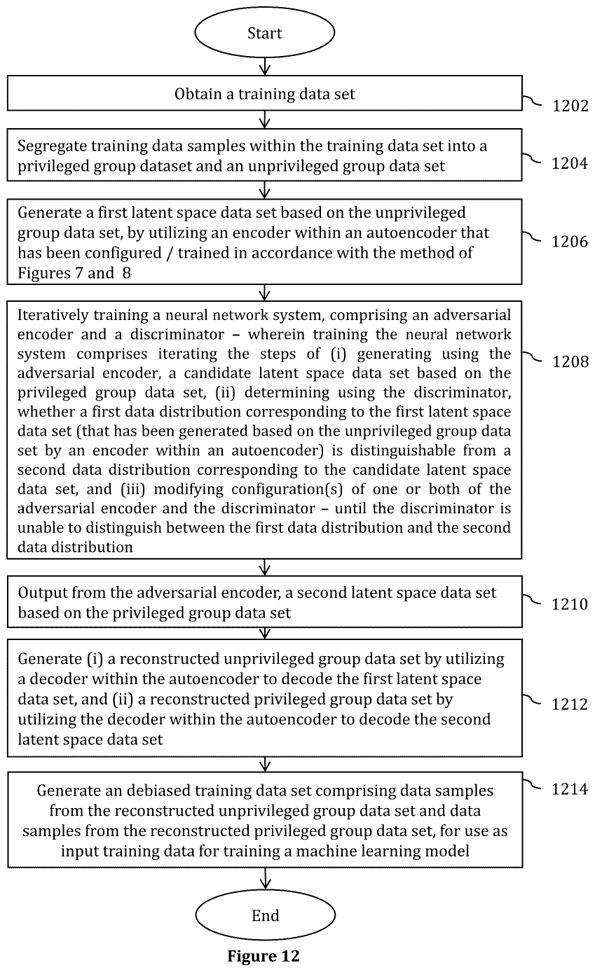

FIG. 12 is a flowchart illustrating a detailed embodiment of a method for debiasing training data by utilizing the system of FIG. 11, in accordance with teachings of the present invention.

Step 1202 comprises obtaining a training data set 1102. Training data set 1102 is obtained for the purposes of training a machine learning model. Training data set 1102 comprises a plurality of data samples that are intended to be used as inputs for training or configuring the machine learning model.

Step 1204 comprises classifying and segregating training data samples within the training data set 1102 into a privileged group data set 1106 and an unprivileged group data set 1104. As described in connection with FIG. 11, classification and segregation of an individual data sample as a privileged group data sample or as an unprivileged group data sample may be based on identification of one or more attributes of said individual data sample that is/are an identifier(s) of membership within or association within a privileged group or an unprivileged group respectively.

Step 1206 generating a first latent space data set 1108 based on the unprivileged group data set 1104, by utilizing an encoder 704 within an autoencoder 708 that has been configured/trained in accordance with the methods of FIGS. 7 and 8. In an embodiment of step 1206, the unprivileged group data set 1104 is provided as input to encoder 704 within autoencoder 700—and encoder 704 encodes the unprivileged group data set 1104 into first latent space data set 1108.

Step 1208 comprises iteratively training neural network system 900, comprising an adversarial encoder 904 and a discriminator 908—wherein training neural network system 900 (and/or one or both of adversarial encoder 904 and discriminator 908) comprises iterating the steps of (i) generating using the adversarial encoder 904, a candidate latent space data set based on the privileged group data set 1106, (ii) determining using the discriminator 908, whether a first data distribution corresponding to a first latent space data set 1108 (that has been generated based on the unprivileged group data set 1104 by encoder 704 within autoencoder 700) is distinguishable from a second data distribution corresponding to the candidate latent space data set, and (iii) modifying configuration(s) of one or both of the adversarial encoder 904 and the discriminator 908—until the discriminator 908 is unable to distinguish between the first data distribution and the second data distribution. In an embodiment, the iterative training of the adversarial encoder 904 and discriminator 908 within generative adversarial encoder 900 continues until the first data distribution within (or associated with) the candidate latent space data set that has been output by adversarial encoder 904 satisfies a defined similarity threshold when compared with the second data distribution within (or associated with) the first latent space data set 1108 that has been generated by the encoder 704 of the autoencoder 700.

Step 1210 comprises utilizing the adversarial encoder 904 that has been trained/configured at step 1208, for providing as output, a second latent space data set 1110 based on the privileged group data set 1106—wherein a first data distribution within (or associated with) the output second latent space data set satisfies a defined similarity threshold when compared with a second data distribution within (or associated with) the first latent space data set 1108 that has been generated by the encoder 704 of the autoencoder 700. In an embodiment of step 1210, the second latent space data set 1110 that is output at step 1210 is the candidate latent space data set that has been output by adversarial encoder 904 at step 1208, and which has a first data distribution within (or associated with) said candidate latent space data set that satisfies a defined similarity threshold when compared with the second data distribution within (or associated with) the first latent space data set 1108.

Step 1212 comprises generating (i) a reconstructed unprivileged group data set 1122—by utilizing decoder 708 within autoencoder 700 to decode the first latent space data set 1108, and (ii) a reconstructed privileged group data set 1114 by utilizing decoder 708 within autoencoder 700 to decode the second latent space data set 1110.

Step 1214 comprises generating an debiased data set 1116 comprising data samples from the reconstructed unprivileged group data set 1112 and data samples from the reconstructed privileged group data set 1114, for use as input training data for training a machine learning model. In an embodiment, step 1214 comprises generating the debiased data set 1116 by aggregating data samples from the reconstructed unprivileged group data set 1112 and data samples from the reconstructed privileged group data set 1114.

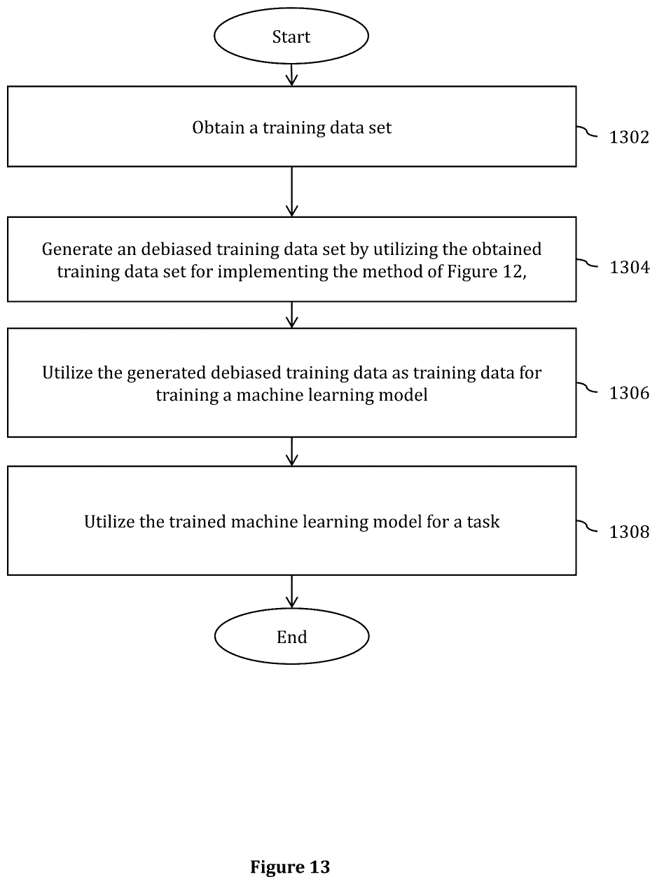

FIG. 13 is a flowchart illustrating a method of training a machine learning model (of a kind shown in FIG. 3) using debiased training data arising from the method of FIG. 12, and thereafter utilizing the trained machine learning model.

Step 1302 comprises obtaining a training data set 1102. Training data set 1102 is obtained for the purposes of training a machine learning model. Training data set 1102 comprises a plurality of data samples that are intended to be used as inputs for training or configuring the machine learning model. Training data set 1102 comprises instances of privileged group data samples as well as unprivileged group data samples.

Step 1304 comprises generating a debiased training data set by utilizing the obtained training data set for implementing the method of FIG. 12.

Step 1306 comprises utilizing the generated debiased training data as training data for training or configuring a machine learning model. In an embodiment, the machine learning model is iteratively trained using the debiased training data, until the machine learning model is found to conform to one or more defined acceptability criteria associated with a defined task.

Step 1308 comprises utilize the trained machine learning model for performing or executing the defined task.

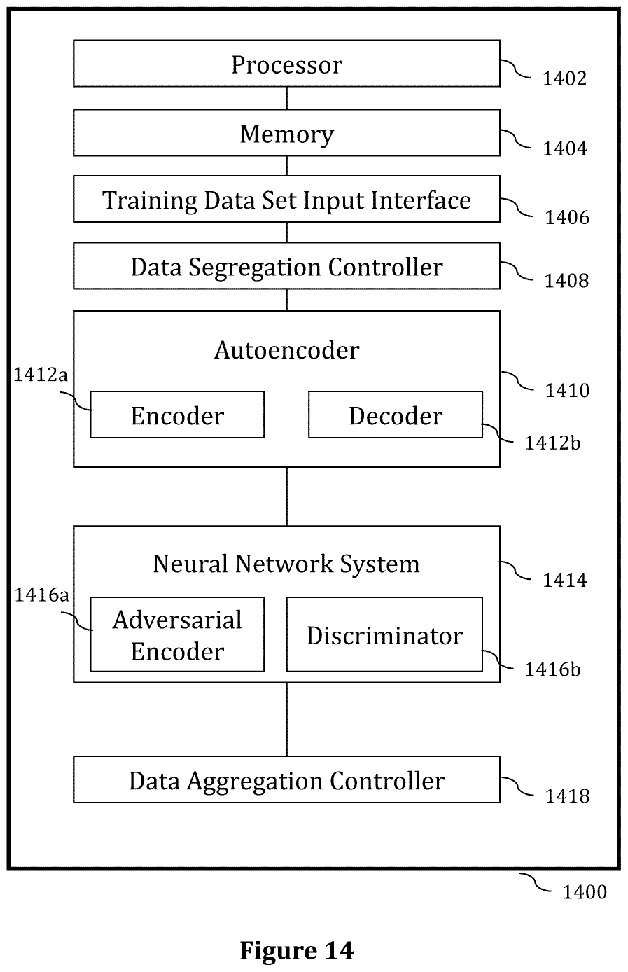

FIG. 14 illustrates an exemplary system 1400 configured to implement the methods of the present invention.

System 1400 comprises a processor 1402 and a memory 1404.

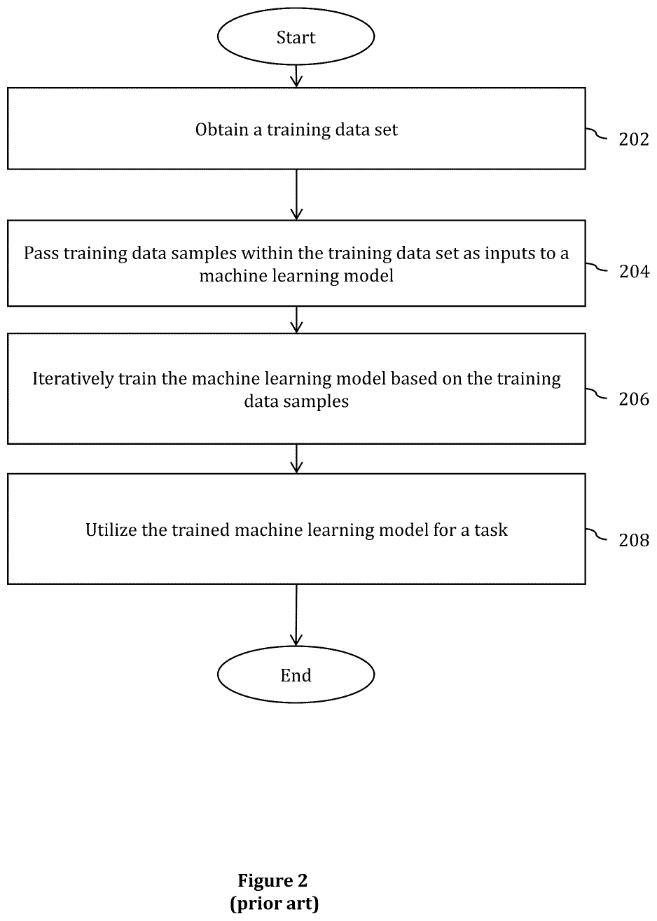

Additionally, system 1400 comprises training data set input interface 1406. Training data set input interface 1406 is a processor implemented interface that is configured for system 1400 to obtain a training data set (for example, a training data set that requires to be debiased) in accordance with any of step 202 (of FIG. 2), step 402 (of FIG. 4), step 602 (of FIG. 6), step 1002 (of FIG. 10), step 1202 (of FIG. 12) and step 1302 (of FIG. 13), as described hereinabove.

System 1400 includes a data segregation controller 1408 that is configured to classify and segregate data samples within a training data set (that has been obtained through training data set input interface 1406) into instances of privileged group data samples and instances of unprivileged group data samples. In an embodiment classification and segregation of an individual data sample as a privileged group data sample or as an unprivileged group data sample may be based on identification of one or more attributes of said individual data sample that is/are an identifier(s) of membership within or association within a privileged group or an unprivileged group respectively. Data segregation controller 1408 may additionally be configured to aggregate privileged group data samples into a privileged group data set, and to aggregate unprivileged group data samples into an un privileged group data set—in accordance with any of step 604 (of FIG. 6), step 1004 (of FIG. 10), and step 1204 (of FIG. 12), as described hereinabove.

System 1400 includes a processor implemented autoencoder 1410, comprising a processor implemented encoder 1412a and a processor implemented decoder 1412b. Each of autoencoder 1410, encoder 1412a and decoder 1412b may be configured in accordance with the configuration and attributes for an autoencoder, and corresponding encoder and decoder, as described above in connection with FIGS. 7, 8, 10, 11, and 12 hereinabove.

System 1400 includes a processor implemented autoencoder 1410, comprising a processor implemented encoder 1412a and a processor implemented decoder 1412b. Each of autoencoder 1410, encoder 1412a and decoder 1412b may be configured in accordance with the configuration and attributes for an autoencoder, and corresponding encoder and decoder, as described above in connection with FIGS. 7, 8, 10, 11, and 12 hereinabove.

System 1400 also includes a processor implemented neural network system 1414, comprising a processor implemented adversarial encoder 1416a and a processor implemented discriminator 1416b. Each of neural network system 1414, adversarial encoder 1416a and discriminator 1416b may be configured in accordance with the configuration and attributes for a neural network system comprising an adversarial encoder and discrimination, and for the corresponding adversarial encoder and discriminator, as described above in connection with FIGS. 9, 10, 11, and 12 hereinabove.

System 1400 additionally includes a processor implemented data aggregation controller 1418, for aggregating reconstructed privileged group data and reconstructing unprivileged group data into a debiased data set that can be used for training a machine learning model. In an embodiment, data aggregation controller 1418 may be utilized for implementing step 1214 of the method of FIG. 12.

The invention provides a computer implemented method for debiasing training data for training a machine learning model. In an embodiment, the method comprises implementing at, at least one processor, the steps of (i) obtaining a training data set comprising a plurality of data samples for use as inputs for training the machine learning model, wherein the plurality of data samples includes privileged group data samples and unprivileged group data samples, (ii) segregating the plurality of data samples into (a) a privileged group data set comprising the privileged group data samples, and (b) an unprivileged group data set comprising the unprivileged group data samples, (iii) generating a first latent space data set based on the unprivileged group data set, wherein generating the first latent space data set comprises (c) providing the unprivileged group data set to an encoder within an autoencoder, said autoencoder comprising the encoder and a decoder, and (d) generating the first latent space data set by encoding the unprivileged group data set at the encoder, (iv) generating a second latent space data set based on the privileged group data set, wherein generating the second latent space data set comprises (e)providing the privileged group data set to an adversarial encoder, (f) providing the first latent space data set to a discriminator, and (g) generating the second latent space data set by encoding the privileged group data set at the adversarial encoder, such that a second data distribution corresponding to the second latent space data set satisfies a defined similarity threshold when compared with a first data distribution corresponding to the first latent space data set, (v) generating a reconstructed unprivileged group data set based on the first latent space data set, (vi) generating a reconstructed privileged group data set based on the second latent space data set, and (vii) generating a debiased training data set comprising data samples from each of the reconstructed unprivileged group data set and the reconstructed privileged group data set.

In a further embodiment of the method (i) the machine learning model is iteratively trained based on data samples within the debiased training data set, and (ii) the trained machine learning model is utilized to perform a defined data processing task.

In a particular method embodiment, the autoencoder is configured such that (i) the encoder is configured to (a) receive the unprivileged group data set, and (b) generate the first latent space data set based on the unprivileged group data set, and (ii) the decoder is configured for at least one of (c) receiving the first latent space data set and generating the reconstructed unprivileged group data set based on the first latent space data set, and (d) receiving the second latent space data set and generating the reconstructed privileged group data set based on the second latent space data set.

In a more particular embodiment of the method, the autoencoder is trained by iteratively training the encoder and decoder based on input data, such that (i) a measured reconstruction loss associated with performance of the encoder and decoder for respectively encoding of input data and subsequent decoding of the encoded input data, is less than a first predefined loss value, or (ii) a measured main task classification loss associated with performance of the encoder and decoder for respectively encoding of input data and subsequent decoding of the encoded input data, is less than a second predefined loss value, or (iii) a measured total loss associated with performance of the encoder and decoder for respectively encoding of input data and subsequent decoding of the encoded input data, is less than a third predefined loss value, wherein the measured total loss includes a sum of the measured reconstruction loss and the measured main task classification loss.

In a further method embodiment (i) the adversarial encoder is configured to (a) receive as input, the privileged group data set, and (b) generate the second latent space data set based on the privileged group data set, and (ii) the discriminator is configured to (c) receive as input a candidate latent space data set that has been output by the adversarial encoder, and (d) determine whether data distribution corresponding to the candidate latent space data set satisfies a defined similarity threshold when compared with data distribution within a reference latent space data set.

In another embodiment of the method (i) a dimensionality of the first latent space data set is less than a dimensionality of the unprivileged group data set, or (ii) a dimensionality of the second latent space data set is less than a dimensionality of the privileged group data set.

The invention also provides a system for debiasing training data for training a machine learning model. In an embodiment the system comprises at least a processor implemented autoencoder, a processor implemented adversarial encoder, and a processor implemented discriminator—wherein the system is configured to perform the steps of (i) obtaining a training data set comprising a plurality of data samples for use as inputs for training the machine learning model, wherein the plurality of data samples includes privileged group data samples and unprivileged group data samples, (ii) segregating the plurality of data samples into (a) a privileged group data set comprising the privileged group data samples, and (b) an unprivileged group data set comprising the unprivileged group data samples, (iii) generating a first latent space data set based on the unprivileged group data set, wherein generating the first latent space data set comprises (c) providing the unprivileged group data set to an encoder within an autoencoder, said autoencoder comprising the encoder and a decoder, and (d) generating the first latent space data set by encoding the unprivileged group data set at the encoder, (iv) generating a second latent space data set based on the privileged group data set, wherein generating the second latent space data set comprises (e)providing the privileged group data set to an adversarial encoder, (f) providing the first latent space data set to a discriminator, and (g) generating the second latent space data set by encoding the privileged group data set at the adversarial encoder, such that a second data distribution corresponding to the second latent space data set satisfies a defined similarity threshold when compared with a first data distribution corresponding to the first latent space data set, (v) generating a reconstructed unprivileged group data set based on the first latent space data set, (vi) generating a reconstructed privileged group data set based on the second latent space data set, and (vii) generating a debiased training data set comprising data samples from each of the reconstructed unprivileged group data set and the reconstructed privileged group data set.

In a further embodiment of the system (i) the machine learning model is iteratively trained based on data samples within the debiased training data set, and (ii) the trained machine learning model is utilized to perform a defined data processing task.

In a particular system embodiment, the autoencoder is configured such that (i) the encoder is configured to (a) receive the unprivileged group data set, and (b) generate the first latent space data set based on the unprivileged group data set, and (ii) the decoder is configured for at least one of (c) receiving the first latent space data set and generating the reconstructed unprivileged group data set based on the first latent space data set, and (d) receiving the second latent space data set and generating the reconstructed privileged group data set based on the second latent space data set.

In a more particular embodiment of the system, the autoencoder is trained by iteratively training the encoder and decoder based on input data, such that (i) a measured reconstruction loss associated with performance of the encoder and decoder for respectively encoding of input data and subsequent decoding of the encoded input data, is less than a first predefined loss value, or (ii) a measured main task classification loss associated with performance of the encoder and decoder for respectively encoding of input data and subsequent decoding of the encoded input data, is less than a second predefined loss value, or (iii) a measured total loss associated with performance of the encoder and decoder for respectively encoding of input data and subsequent decoding of the encoded input data, is less than a third predefined loss value, wherein the measured total loss includes a sum of the measured reconstruction loss and the measured main task classification loss.

In a further system embodiment (i) the adversarial encoder is configured to (a) receive as input, the privileged group data set, and (b) generate the second latent space data set based on the privileged group data set, and (ii) the discriminator is configured to (c) receive as input a candidate latent space data set that has been output by the adversarial encoder, and (d) determine whether data distribution corresponding to the candidate latent space data set satisfies a defined similarity threshold when compared with data distribution within a reference latent space data set.

In another embodiment of the system (i) a dimensionality of the first latent space data set is less than a dimensionality of the unprivileged group data set, or (ii) a dimensionality of the second latent space data set is less than a dimensionality of the privileged group data set.

The invention additionally provides a computer program product for debiasing training data for training a machine learning model. The computer program product comprises a non-transitory computer readable medium having a computer readable program code embodied therein, wherein the computer readable program code comprises instructions for performing at, at least one processor, the steps of (i) obtaining a training data set comprising a plurality of data samples for use as inputs for training the machine learning model, wherein the plurality of data samples includes privileged group data samples and unprivileged group data samples, (ii) segregating the plurality of data samples into (a) a privileged group data set comprising the privileged group data samples, and (b) an unprivileged group data set comprising the unprivileged group data samples, (iii) generating a first latent space data set based on the unprivileged group data set, wherein generating the first latent space data set comprises (c) providing the unprivileged group data set to an encoder within an autoencoder, said autoencoder comprising the encoder and a decoder, and (d) generating the first latent space data set by encoding the unprivileged group data set at the encoder, (iv) generating a second latent space data set based on the privileged group data set, wherein generating the second latent space data set comprises (e)providing the privileged group data set to an adversarial encoder, (f) providing the first latent space data set to a discriminator, and (g) generating the second latent space data set by encoding the privileged group data set at the adversarial encoder, such that a second data distribution corresponding to the second latent space data set satisfies a defined similarity threshold when compared with a first data distribution corresponding to the first latent space data set, (v) generating a reconstructed unprivileged group data set based on the first latent space data set, (vi) generating a reconstructed privileged group data set based on the second latent space data set, and (vii) generating a debiased training data set comprising data samples from each of the reconstructed unprivileged group data set and the reconstructed privileged group data set.

In a further embodiment of the computer program product (i) the machine learning model is iteratively trained based on data samples within the debiased training data set, and (ii) the trained machine learning model is utilized to perform a defined data processing task.

In a particular computer program product embodiment, the autoencoder is configured such that (i) the encoder is configured to (a) receive the unprivileged group data set, and (b) generate the first latent space data set based on the unprivileged group data set, and (ii) the decoder is configured for at least one of (c) receiving the first latent space data set and generating the reconstructed unprivileged group data set based on the first latent space data set, and (d) receiving the second latent space data set and generating the reconstructed privileged group data set based on the second latent space data set.

In a more particular embodiment of the computer program product, the autoencoder is trained by iteratively training the encoder and decoder based on input data, such that (i) a measured reconstruction loss associated with performance of the encoder and decoder for respectively encoding of input data and subsequent decoding of the encoded input data, is less than a first predefined loss value, or (ii) a measured main task classification loss associated with performance of the encoder and decoder for respectively encoding of input data and subsequent decoding of the encoded input data, is less than a second predefined loss value, or (iii) a measured total loss associated with performance of the encoder and decoder for respectively encoding of input data and subsequent decoding of the encoded input data, is less than a third predefined loss value, wherein the measured total loss includes a sum of the measured reconstruction loss and the measured main task classification loss.

In a further computer program product embodiment (i) the adversarial encoder is configured to (a) receive as input, the privileged group data set, and (b) generate the second latent space data set based on the privileged group data set, and (ii) the discriminator is configured to (c) receive as input a candidate latent space data set that has been output by the adversarial encoder, and (d) determine whether data distribution corresponding to the candidate latent space data set satisfies a defined similarity threshold when compared with data distribution within a reference latent space data set.

In another embodiment of the computer program product (i) a dimensionality of the first latent space data set is less than a dimensionality of the unprivileged group data set, or (ii) a dimensionality of the second latent space data set is less than a dimensionality of the privileged group data set.

Various embodiments of the present disclosure provide multiple advantages and technical effects while addressing technical problems such as enabling generation of debiased data set(s) that may be used as training data for machine learning models. To that end, the various embodiments of the present disclosure provide an approach processing input data to reduce or eliminate biases in the input data, and to generate debiased output data that can be used as machine learning model training data. The present disclosure describes various specifically configured or specifically trained processor implemented machine-learning based models (including for example, specifically configured autoencoders and neural network systems) that are configured or trained to perform the methods of the present invention.

Various embodiments of the present invention are described hereinabove with reference to FIGS. 4 to 15. Exemplary applications of the proposed invention have been described hereinabove in connection with FIGS. 5, 11 and 13.

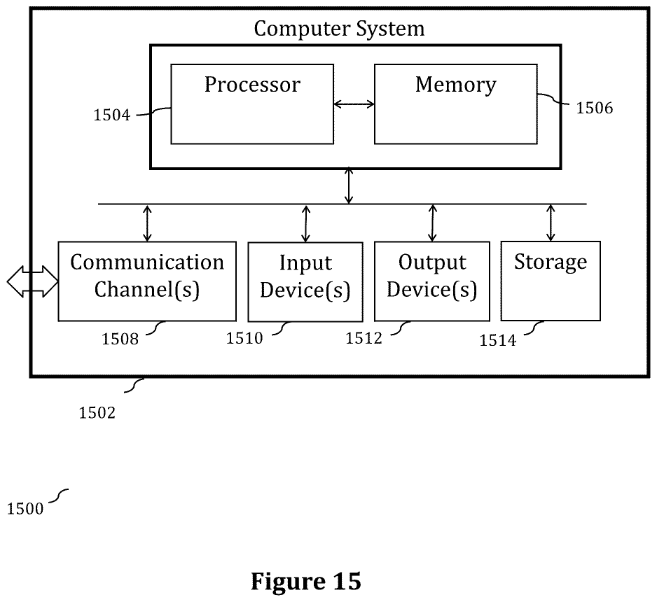

FIG. 15 illustrates an exemplary computer system according to which various embodiments of the present invention may be implemented.

System 1500 includes computer system 1502 which in turn comprises one or more processors 1504 and at least one memory 1506. Processor 1504 is configured to execute program instructions-and may be a real processor or a virtual processor. It will be understood that computer system 1502 does not suggest any limitation as to scope of use or functionality of described embodiments. The computer system 1502 may include, but is not limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 1502 in accordance with the present invention may include one or more servers, desktops, laptops, tablets, smart phones, mobile phones, mobile communication devices, phablets and personal digital assistants. In an embodiment of the present invention, the memory 1506 may store software for implementing various embodiments of the present invention. The computer system 1502 may have additional components. For example, the computer system 1502 may include one or more communication channels 1508, one or more input devices 1510, one or more output devices 1512, and storage 1514. An interconnection mechanism (not shown) such as a bus, controller, or network, interconnects the components of the computer system 1502. In various embodiments of the present invention, operating system software (not shown) provides an operating environment for various softwares executing in the computer system 1502 using a processor 1504, and manages different functionalities of the components of the computer system 1502.

The communication channel(s) 1508 allow communication over a communication medium to various other computing entities. The communication medium provides information such as program instructions, or other data in a communication media. The communication media includes, but is not limited to, wired or wireless or contactless methodologies implemented with an electrical, optical, RF, infrared, acoustic, microwave, Bluetooth or other transmission media.

The input device(s) 1510 may include, but is not limited to, a touch screen, a keyboard, mouse, pen, joystick, trackball, a voice device, a scanning device, or any another device that is capable of providing input to the computer system 1502. In an embodiment of the present invention, the input device(s) 1510 may be a sound card or similar device that accepts audio input in analog or digital form. The output device(s) 1512 may include, but not be limited to, a user interface on CRT, LCD, LED display, or any other display associated with any of servers, desktops, laptops, tablets, smart phones, mobile phones, mobile communication devices, phablets and personal digital assistants, printer, speaker, CD/DVD writer, or any other device that provides output from the computer system 1502.

The storage 1514 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1502. In various embodiments of the present invention, the storage 1514 may contain program instructions for implementing any of the described embodiments.

In an embodiment of the present invention, the computer system 1502 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1502. The method described herein is typically implemented as a computer program product, comprising a set of program instructions that is executed by the computer system 1502 or any other similar device. The set of program instructions may be a series of computer readable codes stored on a tangible medium, such as a computer readable storage medium (storage 1514), for example, diskette, CD-ROM, ROM, flash drives or hard disk, or transmittable to the computer system 1502, via a modem or other interface device, over either a tangible medium, including but not limited to optical or analogue communications channel(s) 1508. The implementation of the invention as a computer program product may be in an intangible form using wireless or contactless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

As a result of implementing the above teachings, the present invention enables generation of debiased data set(s) that may be used as training data for machine learning models—with a consequent reduction or elimination of machine learning model biases, and leading to higher reliability and accuracy in tasks implemented by machine learning models that have been trained based on the debiased data set(s).

While exemplary embodiments of the present invention are described and illustrated herein, it will be appreciated that they are merely illustrative. It will be understood by those skilled in the art that various modifications in form and detail may be made therein without departing from the scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

We claim:

1. A computer implemented method for debiasing training data for training a machine learning model, the method comprising implementing at, at least one processor, the steps of:
obtaining a training data set comprising a plurality of data samples for use as inputs for training the machine learning model, wherein the plurality of data samples includes privileged group data samples and unprivileged group data samples;
segregating the plurality of data samples into:
a privileged group data set comprising the privileged group data samples; and
an unprivileged group data set comprising the unprivileged group data samples;
generating a first latent space data set based on the unprivileged group data set, wherein generating the first latent space data set comprises:
providing the unprivileged group data set to an encoder within an autoencoder, said autoencoder comprising the encoder and a decoder; and
generating the first latent space data set by encoding the unprivileged group data set at the encoder;
generating a second latent space data set based on the privileged group data set, wherein generating the second latent space data set comprises:
providing the privileged group data set to an adversarial encoder;
providing the first latent space data set to a discriminator; and
generating the second latent space data set by encoding the privileged group data set at the adversarial encoder, such that a second data distribution corresponding to the second latent space data set satisfies a defined similarity threshold when compared with a first data distribution corresponding to the first latent space data set;
generating a reconstructed unprivileged group data set based on the first latent space data set;
generating a reconstructed privileged group data set based on the second latent space data set; and
generating a debiased training data set comprising data samples from each of the reconstructed unprivileged group data set and the reconstructed privileged group data set.

2. The method as claimed in claim 1, wherein:
the machine learning model is iteratively trained based on data samples within the debiased training data set; and
the trained machine learning model is utilized to perform a defined data processing task.

3. The method as claimed in claim 1, wherein the autoencoder is configured such that:
the encoder is configured to:
receive the unprivileged group data set; and
generate the first latent space data set based on the unprivileged group data set;
and the decoder is configured for at least one of:
receiving the first latent space data set and generating the reconstructed unprivileged group data set based on the first latent space data set; and
receiving the second latent space data set and generating the reconstructed privileged group data set based on the second latent space data set.

4. The method as claimed in claim 3, wherein the autoencoder is trained by iteratively training the encoder and decoder based on input data, such that:
a measured reconstruction loss associated with performance of the encoder and decoder for respectively encoding of input data and subsequent decoding of the encoded input data, is less than a first predefined loss value; or
a measured main task classification loss associated with performance of the encoder and decoder for respectively encoding of input data and subsequent decoding of the encoded input data, is less than a second predefined loss value; or
a measured total loss associated with performance of the encoder and decoder for respectively encoding of input data and subsequent decoding of the encoded input data, is less than a third predefined loss value, wherein the measured total loss includes a sum of the measured reconstruction loss and the measured main task classification loss.

5. The method as claimed in claim 1, wherein:
the adversarial encoder is configured to:
receive as input, the privileged group data set; and
generate the second latent space data set based on the privileged group data set;
and the discriminator is configured to:
receive as input a candidate latent space data set that has been output by the adversarial encoder; and
determine whether data distribution corresponding to the candidate latent space data set satisfies a defined similarity threshold when compared with data distribution within a reference latent space data set.

6. The method as claimed in claim 1, wherein:
a dimensionality of the first latent space data set is less than a dimensionality of the unprivileged group data set; or
a dimensionality of the second latent space data set is less than a dimensionality of the privileged group data set.

7. A system for debiasing training data for training a machine learning model, the system comprising at least a processor implemented autoencoder, a processor implemented adversarial encoder, and a processor implemented discriminator, wherein the system is configured to perform the steps of:
obtaining a training data set comprising a plurality of data samples for use as inputs for training the machine learning model, wherein the plurality of data samples includes privileged group data samples and unprivileged group data samples;
segregating the plurality of data samples into:
a privileged group data set comprising the privileged group data samples; and
an unprivileged group data set comprising the unprivileged group data samples;
generating a first latent space data set based on the unprivileged group data set, wherein generating the first latent space data set comprises:
providing the unprivileged group data set to an encoder within the autoencoder, said autoencoder comprising the encoder and a decoder; and
generating the first latent space data set by encoding the unprivileged group data set at the encoder;
generating a second latent space data set based on the privileged group data set, wherein generating the second latent space data set comprises:
providing the privileged group data set to the adversarial encoder;
providing the first latent space data set to the discriminator; and
generating the second latent space data set by encoding the privileged group data set at the adversarial encoder, such that a second data distribution corresponding to the second latent space data set satisfies a defined similarity threshold when compared with a first data distribution corresponding to the first latent space data set;
generating a reconstructed unprivileged group data set based on the first latent space data set;
generating a reconstructed privileged group data set based on the second latent space data set;
generating a debiased training data set comprising data samples from each of the reconstructed unprivileged group data set and the privileged group data set.

8. The system as claimed in claim 7, wherein:
the machine learning model is iteratively trained based on data samples within the debiased training data set; and
the trained machine learning model is utilized to perform a defined data processing task.

9. The system as claimed in claim 7, wherein the autoencoder is configured such that:
the encoder is configured to:
receive the unprivileged group data set; and
generate the first latent space data set based on the unprivileged group data set;
and the decoder is configured for at least one of:
receiving the first latent space data set and generating the reconstructed unprivileged group data set based on the first latent space data set; and
receiving the second latent space data set and generating the reconstructed privileged group data set based on the second latent space data set.

10. The system as claimed in claim 9, wherein the autoencoder is trained by iteratively training the encoder and decoder based on input data, such that:
a measured reconstruction loss associated with performance of the encoder and decoder for respectively encoding of input data and subsequent decoding of the encoded input data, is less than a first predefined loss value; or
a measured main task classification loss associated with performance of the encoder and decoder for respectively encoding of input data and subsequent decoding of the encoded input data, is less than a second predefined loss value; or
a measured total loss associated with performance of the encoder and decoder for respectively encoding of input data and subsequent decoding of the encoded input data, is less than a third predefined loss value, wherein the measured total loss includes a sum of the measured reconstruction loss and the measured main task classification loss.

11. The system as claimed in claim 7, wherein:
the adversarial encoder is configured to:
receive as input, the privileged group data set; and
generate the second latent space data set based on the privileged group data set;
and the discriminator is configured to:
receive as input a candidate latent space data set that has been output by the adversarial encoder; and
determine whether data distribution corresponding to the candidate latent space data set satisfies a defined similarity threshold when compared with data distribution within a reference latent space data set.

12. The system as claimed in claim 7, wherein:
a dimensionality of the first latent space data set is less than a dimensionality of the unprivileged group data set; or
a dimensionality of the second latent space data set is less than a dimensionality of the privileged group data set.

13. A computer program product for debiasing training data for training a machine learning model, the computer program product comprising a non-transitory computer readable medium having a computer readable program code embodied therein, wherein the computer readable program code comprises instructions for performing at, at least one processor, the steps of:
obtaining a training data set comprising a plurality of data samples for use as inputs for training the machine learning model, wherein the plurality of data samples includes privileged group data samples and unprivileged group data samples;
segregating the plurality of data samples into:
a privileged group data set comprising the privileged group data samples; and
an unprivileged group data set comprising the unprivileged group data samples;
generating a first latent space data set based on the unprivileged group data set, wherein generating the first latent space data set comprises:
providing the unprivileged group data set to an encoder within an autoencoder, said autoencoder comprising the encoder and a decoder; and
generating the first latent space data set by encoding the unprivileged group data set at the encoder;
generating a second latent space data set based on the privileged group data set, wherein generating the second latent space data set comprises:
providing the privileged group data set to an adversarial encoder;
providing the first latent space data set to a discriminator; and
generating the second latent space data set by encoding the privileged group data set at the adversarial encoder, such that a second data distribution corresponding to the second latent space data set satisfies a defined similarity threshold when compared with a first data distribution corresponding to the first latent space data set;
generating a reconstructed unprivileged group data set based on the first latent space data set;
generating a reconstructed privileged group data set based on the second latent space data set;
generating a debiased training data set comprising data samples from each of the reconstructed unprivileged group data set and the privileged group data set.
